(19) United States
(12) Patent Application Publication
(10) Pub. No.: US 2015/0035298 A1
(43) Pub. Date: Feb. 5, 2015

(54) DOOR HANDLE UNIT HAVING A LINEAR DAMPER

(71) Applicant: Fuji Latex Co., Ltd., Tokyo (JP)

(72) Inventor: Takashi YOKOO, Tokyo (JP)

(21) Appl. No.: 14/333,991

(22) Filed: Jul. 17, 2014

(30) Foreign Application Priority Data
Aug. 2, 2013 (JP) 2013-161682

(51) Int. Cl. E05B 17/00; E05B 7/00

(52) U.S. Cl. CPC E05B 17/0041; E05B 7/00
USPC 292/336.3

(57) ABSTRACT

A door handle unit includes an unit case, a door handle rotatably supported with the unit case for rotational manipulation, a rotary shaft connected to the door handle so as to be rotated through the rotational manipulation of the door handle, a latch connected to the rotary shaft so as to be operated by the rotary shaft rotating through the rotational manipulation of the door handle, a spring applying a biasing force to return the door handle to an original rotational position before the rotational manipulation, an arm provided on the rotary shaft, and a linear damper contacting with the arm to damp the rotation of the door handle only when the door handle returns to the original rotational position before the rotational manipulation.

### BACKGROUND OF THE INVENTION

1. Field of the Invention

The present invention relates to a door handle unit for buildings, vehicles, or the like.

2. Description of Related Art

Conventionally, there is a door handle unit as disclosed in JP2002-235471A. The door handle unit includes a rotatably-supported door handle for rotational manipulation by a person, a coil spring for returning the door handle, and a one-way rotary damper for damping the returning door handle.

When manually rotating the door handle by the rotational manipulation in order to operate a latch, the rotary damper does not fulfill the function. When releasing a hand from the door handle after the operation of the latch, the door handle rotates back into an original rotational position according to a biasing force of the coil spring so that a contact portion on the door handle comes into contact with a stopper on a stationary side of the door handle unit. As a result, the door handle is positioned at the original rotational position before the rotational manipulation. During the door handle is rotating back into the original rotational position, the rotary damper puts a brake on the rotating door handle based on the damping effect to absorb the shock at the time of the contact between the contact portion and the stopper.

The one-way rotary damper, however, produces a resistance torque due to a seal or the like of the damper even when manually rotating the door handle from the original rotational position. Therefore, there is a limit in reducing an operating physical force when manually rotating the door handle.

### SUMMARY OF THE INVENTION

An object of the present invention is to provide a door handle unit capable of further reducing the operating physical force when manually rotating the door handle.

In order to accomplish the object, an aspect of the present invention provides a door handle unit including an unit case, a door handle rotatably supported with the unit case for rotational manipulation, a rotary shaft connected to the door handle to rotate together with the door handle, a latch connected to the rotary shaft so as to be operated by the rotary shaft rotating through the rotational manipulation of the door handle, a spring applying a biasing force to rotate the door handle back into an original rotational position before the rotational manipulation, an arm provided on the rotary shaft, and a linear damper contacting with the arm to damp a rotation of the door handle only when the door handle rotates back into the original rotational position.

According to the aspect, when manually rotating the door handle by the rotational manipulation to operate the latch, the linear damper does not act on the door handle and not produce a resistance torque, thereby to reduce an operating physical force for the rotational manipulation.

When releasing a hand from the door handle, the door handle rotates back into the original rotational position according to the biasing force of the spring. At this time, the arm contacts with the linear damper. Accordingly, the linear damper damps the rotation of the door handle only when the door handle rotates back into the original rotational position.

### BRIEF DESCRIPTION OF THE DRAWINGS

FIG. 1 is a sectional view illustrating a door handle unit according to a first embodiment of the present invention;

FIG. 2 is a sectional view taken along a line A-A of FIG. 1 and illustrating a relationship between a door handle and an arm before rotational manipulation;

FIG. 3 is a sectional view taken along the line A-A of FIG. 1 and illustrating a relationship between the door handle and the arm after the rotational manipulation;

FIG. 4 is a sectional view illustrating a door handle unit according to a second embodiment of the present invention;

FIG. 5 is a sectional view taken along a line B-B of FIG. 4 and illustrating a relationship between a door handle and an arm before rotational manipulation; and

FIG. 6 is a sectional view taken along the line B-B of FIG. 4 and illustrating a relationship between the door handle and the arm after the rotational manipulation.

### DETAILED DESCRIPTION OF EMBODIMENTS

Embodiments according to the present invention will be explained. A door handle unit of each embodiment is capable of further reducing an operating physical force when manually rotating a door handle.

For this, the door handle unit includes a unit case, a door handle, a rotary shaft, a latch, a spring, an arm, and a linear damper. The door handle is rotatably supported with the unit case for rotational manipulation. The rotary shaft is connected to the door handle to rotate together with the door handle. The latch is connected to the rotary shaft so as to be operated by the rotary shaft rotating through the rotational manipulation of the door handle. The spring applies a biasing force to rotate the door handle back into an original rotational position before the rotational manipulation. The arm is provided on the rotary shaft. The linear damper contacts with the arm to damp a rotation of the door handle only when the door handle rotates back into the original rotational position.

Hereinafter, the embodiments of the present invention will be explained in detail with reference to drawings.

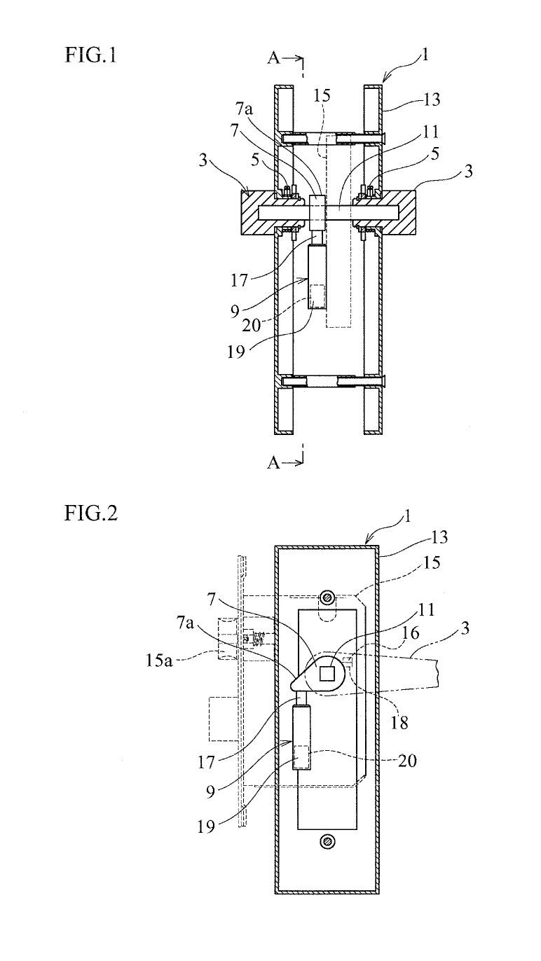

FIG. 1 is a sectional view illustrating a door handle unit according to the first embodiment, FIG. 2 is a sectional view taken along a line A-A of FIG. 1 and illustrating a relationship between a door handle and an arm before rotational manipulation, and FIG. 3 is a sectional view taken along the line AA of FIG. 1 and illustrating a relationship between the door handle and the arm after the rotational manipulation.

As illustrated in FIGS. 1-3, a door handle unit 1 of the first embodiment is for a door applicable to any opening in, for example, buildings, vehicles, or the like. The door handle unit 1 includes a door handle 3, a spring 5, an arm 7, and a linear damper 9.

The door handle 3 is attached or connected to each end of a rotary shaft 11 so that the door handles 3 are positioned inside and outside the door, respectively. The door handle 3 is supported with a unit case 13 through the rotary shaft 11. The door handle 3 is a lever or may be a nob or the other suitable member. The rotary shaft 11 is rotatably supported with the unit case 13 to rotate together with the door handle 3.

The latch assembly 15 includes the latch 15a linked with or connected to the rotary shaft 11 so as to be operated by the rotary shaft 11 rotating through the rotational manipulation of the door handle 3. The latch assembly 15 and the latch 15a may have any suitable structures for the door handle unit 1 having the rotatable door handle 3 or the like.

The latch assembly 15 further includes a stopper 16 therein. Corresponding to the stopper 16, a contact portion 18 is formed on the rotary shaft 11. The contact portion 18 comes into contact with the stopper 16 so that the door handle 3 in a free state is positioned through the rotary shaft 11 at an original rotational position before the rotational manipulation. The contact portion 18 may be formed on any one of the door handle 3, the latch 15a and a linking mechanism (not illustrated) of the latch assembly 15 between the latch 15a and the rotary shaft 11 as a movable side instead of the rotary shaft 11 that is also the movable side. The stopper 16 may be formed on a stationary side relative to the movable side of the door handle unit 1 so that the contact portion 18 corresponds to the stopper 16.

The spring 5 is a torsion spring interposed between the rotary shaft 11 and the unit case 13. According to the embodiment, two springs 5 are interposed between respective ends of the rotary shaft 11 and the unit ease 13, to apply a biasing force to the door handle 3 to rotate the door handle 3 in a free state back into the original rotational position. The configuration, arrangement and the number of the springs 5 may be changed because the spring 5 only has to be configured to apply the biasing force to the door handle 3. Namely, the spring 5 may be formed by a plate spring or the other type of a spring, and may be arranged between the door handle 3 and the unit case 13.

The arm 7 is formed on the rotary shaft 11. According to the embodiment, the arm 7 is prepared as a discrete member separated from the rotary shaft 11 and is fixed thereto by press fitting or the like. The arm 7 may be integrated with the rotary shaft 11,

The arm 7 is a plate cam or a flat plate cam including an outer peripheral surface 7a with which a damper rod 17 of the linear damper 9 contacts. The arm 7 may be have a different shape from the fiat plate cam or be the other suitable member to set different characteristics.

According to the embodiment, the arm 7 extends from the rotary shaft 11 to the opposite side of the door handle 3. The outer peripheral surface 7a becomes narrow toward a front end of the arm 7 distal to the rotary shaft 11. A lower side of the outer peripheral surface 7a is flat and horizontally extends in the original rotational position of the door handle 3. An upper side of the outer peripheral surface 7a is fiat and inclined with respect to horizontal and vertical directions. The arm 7 may have different shape and/or may be arranged at a different position around the rotary shaft 11 according to an arrangement of the linear damper 9 described later and/or required characteristics.

The linear damper 9 has the damper rod 17 and a cylinder 19. The damper rod 17 is supported with the cylinder 19 so as to linearly extend and contract with respect to the cylinder 19. Namely, the damper rod 17 is a movable end of the linear damper 9. An outer end of the damper rod 17 contacts with the outer peripheral surface 7a of the arm 7. The damper rod 17 may have a contact portion that contacts with the outer peripheral surface 7a of the arm 7 instead of the outer end thereof. An inner end of the damper rod 17 is in the cylinder 19. According to the embodiment, the linear damper 9 is arranged so that an axis thereof extends vertically. However, the linear damper 9 may be arranged horizontally or at an angle according to the shape, position or the like of the arm 7. In any arrangement, the arrangement of the linear damper 9 is associated with the shape of the arm 7 so that a pressure angle between the damper rod 17 of the linear damper 9 and the arm 7 gradually increases relative to the axial direction of the damper rod 17 as the door handle 3 rotates back into or returns to the original rotational position. With the shape of the arm 7 and the arrangement of the linear damper 9, the linear damper 9 produces the damping effect from the middle of the return of the door handle 3 to the original rotational position. Therefore, the linear damper 9 damps the rotating door handle 3 only when the door handle 3 rotates back into or returns to the original rotational position before the rotational manipulation.

The cylinder 19 of the linear damper 9 is fixed to an outer surface of the latch assembly 15 or the other suitable area on the stationary side in the door handle unit 1. Namely, the cylinder 19 is a fixed end of the linear damper 9. The linear damper 9 includes a return spring 20.

The return spring 20 is arranged inside the linear damper 9 and applies a biasing force to the damper rod 17. The biasing force of the return spring 20 is less than that of the spring 5. When rotating the door handle 3 by the rotational manipulation, the damper rod 17 linearly extends so as to push the arm 7 upwardly by the return spring 20. With the extension of the damper rod 17, the linear damper 9 assists the rotational manipulation of the door handle 3.

As illustrated in FIGS. 1 and 2, the door handle 3 in a free state before the rotational manipulation has rotated up to a substantial horizontal position, i.e. the original rotational position and keeps the same by the biasing force of the spring 5. In this state, the arm 7 lies on a position that allows a front end of the outer peripheral surface 7a of the arm 7 to push the damper rod 17 into the cylinder 19.

When downwardly rotating the door handle 3 from the original rotational position toward a releasing rotational position by the rotational manipulation, the arm 7 is rotated together with the rotary shaft 11 away from the damper rod 17 as illustrated in FIG. 3. During the rotation, the arm 7 never forcibly pulls the damper rod 17 and the damper rod 17 extends following the rotating arm 7 by the biasing force of the return spring 20 of the linear damper 19 while the outer end of the damper rod 17 contacts with the arm 7.

Therefore, the biasing force for the extension of the damper rod 17 is transmitted through the arm 7 and the rotary shaft 11 to the door handle 3, so that the linear damper 9 assists the rotational manipulation of the door handle 3 to reduce the operating physical force when manually rotating the door handle 3. Further, the linear damper 9 damps the rotating door handle 3 only when the door handle 3 rotates back into the original rotational position before the rotational manipulation. Therefore, no resistance torque due to a seal or the like of the linear damper 19 acts on the door handle 3 and the operating physical force is surely reduced when manually rotating the door handle 3.

As illustrated in FIG. 3, the door handle 3 has been rotated up to the releasing rotational position through the rotational manipulation, the latch 15a of the latch assembly 15 disengages from a recessed portion (not illustrated) of the door to allow a person to open the door.

When releasing a hand of the person from the door handle 3 in the state illustrated in FIG. 3, the spring 5 rotates the door handle 3 back into the state illustrated in FIG. 2, i.e. the original rotational position by the biasing force thereof through the rotatory shaft 11.

In the initial stage of the rotation of the door handle 3 back into the original rotational position, the damper rod 17 strokes or contracts according to the rotation of the arm 7 with a relatively small amount, Namely, the arm 7 pushes the damper rod 17 into the cylinder 19 with the relatively small amount so that the linear damper 9 does not produce the damping effect to allow the door handle 3 to quickly rotate back.

The amount of the stroke of the damper rod 17 becomes gradually large as the rotation of the door handle 3 bake into the original rotational position progresses. Accordingly, the damper rod 17 strokes or contracts according to the rotation of the arm 7 with a relatively large amount from the middle of the return of the door handle 3 to the original rotational position. Then, the linear damper 9 produces the damping effect during the damper rod 17 contracts with the relatively large amount from the middle of the return of the door handle 3 to the original rotational position.

With the damping effect, the linear damper 9 greatly puts a brake on the rotating door handle 3 in particular the rotating rotary shaft 11 until the door handle 3 becomes the state illustrated in FIG. 2 in which the contact portion 18 on the rotary shaft 11 and the stopper 16 on the latch assembly 15 contact with each other. Accordingly, the contact portion 18 comes into softly or slowly contact with the stopper 16 just when the door handle 3 becomes the original rotational position. In this way, the door handle 3 is positioned at the original rotational position before the rotational manipulation.

The effects of the embodiment will be explained.

The door handle unit 1 according to the embodiment includes the unit case 13, the door handle 3 rotatably supported with the unit case 13 for rotational manipulation, the rotary shaft 11 connected to the door handle 3 so as to be rotated through the rotational manipulation of the door handle 3, the latch 15a connected to the rotary shaft 11 so as to be operated by the rotary shaft 11 rotating through the rotational manipulation of the door handle 3, the spring 5 applying the biasing force to rotate the door handle 3 hack into the original rotational position before the rotational manipulation, the arm 7 provided on the rotary shaft 11, and the linear damper 9 contacting with the arm 7 to damp the rotation of the door handle 3 only when the door handle 3 returns to the original rotational position before the rotational manipulation.

The door handle unit 1, therefore, prevents a resistance torque due to a seal or the like of the linear damper 9 from acting on the door handle 3 and surely reduces the operating physical force when manually rotating the door handle 3 by the rotational manipulation to open the door. When releasing a hand from the door handle 3, the door handle 3 returns to the original rotational position before the rotational manipulation according to the biasing force of the spring 5. At this time, the linear damper 9 produces the damping effect to greatly put a brake on the rotation of the door handle 3, in particular the rotary shaft 11. Accordingly, the contact portion 18 on the rotary shaft 11 comes into softly or slowly contact with the stopper 16 on the latch assembly 15, so that the door handle 3 is positioned at the original rotational position before the rotational manipulation. The door handle unit 1, therefore, absorbs the shock and noise at the time of the contact between the contact portion 18 and the stopper 16.

The arm 7 is shaped to operate the linear damper 9 so that the linear damper 9 produces the damping effect from the middle of the return of the door handle 3 to the original rotational position.

When releasing a hand from the door handle 3 after the rotational manipulation, the door handle 3 initially rotates quickly and then rotates slowly so that the linear damper 9 produces the damping effect from the middle of the return of the door handle 3. The door handle unit 1, therefore, surely absorbs the shock and noise at the time of the contact between the contact portion 18 and the stopper 16 while returning the door handle 3 generally quickly.

The arm 7 is the plate cam or the flat plate cam including the outer peripheral surface 7a and the linear damper 9 includes the fixed end that is the cylinder 19 and the movable end that is the damper rod 17 contacting with the outer peripheral surface 7a of the arm 7.

The door handle unit 1, therefore, causes the linear damper 9 to produce the damping effect from the middle of the return of the door handle 3 to the original rotational position with the simplified structure. Further, the door handle unit 1 may provide the different characteristics according to the setting of the outer peripheral surface 7a of the arm 7.

The pressure angle between the linear damper 9 and the arm 7 gradually increases relative to the axial direction of the linear damper 9 as the door handle 3 rotates back into the original rotational position.

The door handle unit 1, therefore, surely causes the linear damper 9 to produce the damping effect from the middle of the return of the door handle 3 to the original rotational position with the simplified structure.

The linear damper 9 assists the rotary shaft 11 to rotate through the rotational manipulation of the door handle 3.

The door handle unit 1, therefore, surely reduces the operating physical force when manually rotating the door handle 3 by the rotational manipulation.

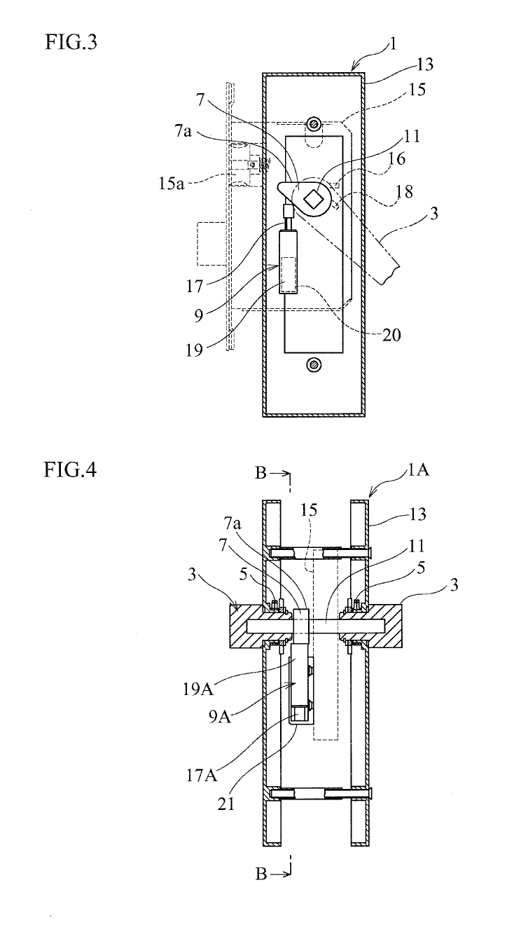

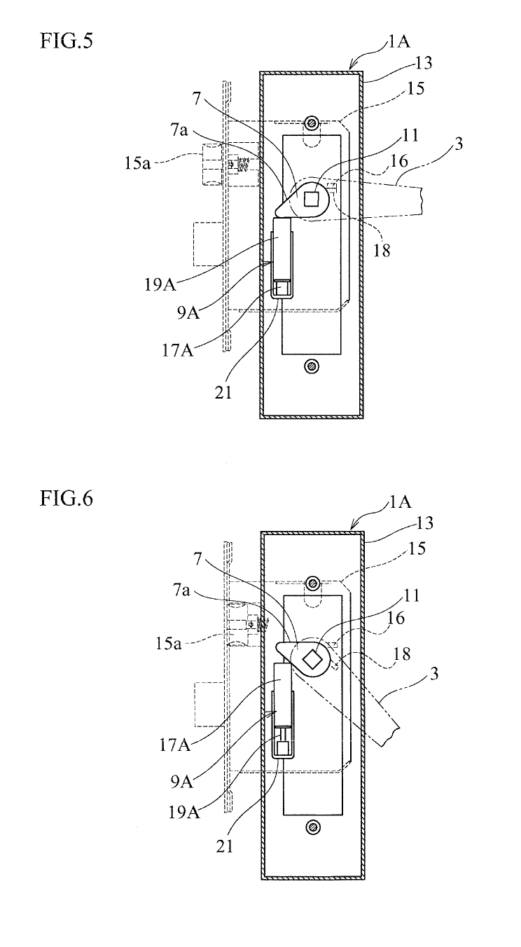

The second embodiment of the present invention will be explained in detail with reference to FIGS. 4 to 6. FIG. 4 is a sectional view illustrating a door handle unit, FIG. 5 is a sectional view taken along a line B-B of FIG. 4 and illustrating a relationship between a door handle and an arm before rotational manipulation, and FIG. 6 is a sectional view taken along the line B-B of FIG. 1 and illustrating a relationship between the door handle and the arm after the rotational manipulation. This embodiment is basically the same as the first embodiment and parts corresponding to those of the first embodiment are represented with the same reference numerals or the same reference numerals with “A” in order to avoid repetition in a description.

The door handle unit 1A according to the embodiment turns a linear damper 9A upside down with respect to the linear damper 9 of the first embodiment. A cylinder 19 of the linear damper 9A is a movable end that contacts with an outer peripheral surface 7a of an arm 7. The arm 7 is a plate cam or flat plate cam like the first embodiment.

The cylinder 19 of the linear damper 9A is supported in a damper supporting case 21 so that the cylinder 19 slides up and down relative to the damper supporting case 21. The damper supporting case 21 is fixed to a latch assembly 15 or the other suitable area on a stationary side of the door handle unit 1A. damper rod 17 of the linear damper 9A is a fixed end that is in contact with an inner bottom of the damper supporting case 21. According to the embodiment, the fixed end of the linear damper 9A is fixed to the stationary side through the damper supporting case 21.

In the door handle unit 1A according to the second embodiment, the linear damper 19 operates up and down according to the rotation of the arm 7 to provide the same effect as the first embodiment.

What is claimed is:

1. A door handle unit comprising:
an unit case;
a door handle rotatably supported with the unit case for rotational manipulation;
a rotary shaft connected to the door handle to rotate together with the door handle;
a latch connected to the rotary shaft so as to be operated by the rotary shaft rotating through the rotational manipulation of the door handle;
a spring applying a biasing force to return the door handle to an original rotational position before the rotational manipulation;
an arm provided on the rotary shaft; and
a linear damper contacting with the arm to damp a rotation of the door handle only when the door handle returns to the original rotational position before the rotational manipulation.

2. The door handle unit of claim 1, wherein the arm is shaped to operate the linear damper so that the linear damper produces a damping effect from a middle of a return of the door handle to the original rotational position.

3. The door handle unit of claim 2, wherein the arm is a plate cam including an outer peripheral surface, and the linear damper includes a fixed end and a movable end that contacts with the outer peripheral surface of the arm.

4. The door handle unit of claim 3, wherein a pressure angle between the linear damper and the arm gradually increases as the door handle rotates back into the original rotational position.

5. The door handle unit of claim 1, wherein the linear damper assists the rotary shaft to rotate through the rotational manipulation of the door handle.

6. The door handle unit of claim 2, wherein the linear damper assists the rotary shaft to rotate through the rotational manipulation of the door handle.

7. The door handle unit of claim 3, wherein the linear damper assists the rotary shaft to rotate through the rotational manipulation of the door handle.

8. The door handle unit of claim 4, wherein the linear damper assists the rotary shaft to rotate through the rotational manipulation of the door handle.
